(19) United States
(12) Patent Application Publication
(10) Pub. No.: US 2004/0173652 A1
(43) Pub. Date: Sep. 9, 2004

(54) CARRY-HAUL

(76) Inventor: James Francis Busta, Cedar Rapids, IA (US)

Correspondence Address: James F. Busta, 9101 Shattucks CT., Cedar Rapids, IA, 52411, US

(21) Appl. No.: 10/377,685

(22) Filed: Mar. 3, 2003

(51) Int. Cl. B62J 7/00; B62J 9/00; B62J 11/00

(52) U.S. Cl. 224/413; 224/433

(57) ABSTRACT

A carrying apparatus for use with a motorcycle having a rearwardly projecting hitch capable of supporting an elongated article such as a golf bag or with the box insert bats, fishing poles, etc. To be carried on said motorcycle with safety in mind. It has upright support of elongated items with a top, connected on both sides with horizontal side support, with adjustable hollow square tubes with a smaller tube inside secured with a pin. On the back side top, to hold the elongated article in place, is another hollow square tube connected to outside supports with pins to hold said article in place. On back support base, brake and running lights are mounted on the outside backsides. Also, license plate and light to illuminate license plate. With the box insert, smaller items will not fall out or off.

### BACKGROUND OF THE INVENTION

Motorcycles are convenient and fun for touring but are limited for what they can carry. Having a trailer hitch on the rear of a motorcycle, it can be used for more than a trailer and using the CARRY-HAUL it can be much cheaper. With a trailer you have added cost of insurance, license plate and storage. The present invention eliminates the need for a trailer to carry or haul items on a motorcycle.

The idea for baggage or luggage carriers for motorcycles is known. The prior art motorcycle baggage carriers usually have a bag strapped above the rear fender of the motorcycle and sometimes in the way of the passenger making it unsafe.

The U.S. Pat. No. 3,329,323 shows an overhead carrier to use to transport a surfboard or anything long and flat. It mounts on both the front handle bars and rear axle.

U.S. Pat. No. 328623 shows an L-shaped unit bolted on the back fender of a motorcycle which could carry a limited number of elongated articles in a safe manner.

U.S. Pat. No. 3,362,596 shows a carrier on the rear part of the motorcycle. This can be used to carry small articles to be enclosed in said carrying unit. It is mounted behind the driver and the fender and/or the rear axle.

U.S. Pat. No. 3,495,749 shows a carrier that bolts to the back horizontal luggage carrier and on each side of the bike. With this design, it eliminates the passenger and the driver can use it for a backrest.

### SUMMARY AND OBJECTS OF THE INVENTION

The present invention is a carrier for use with a motorcycle to support an elongated article. The motorcycle having a rearwardly projecting hitch receiver portion. An elongated support secures at the rectangular shaped base and extends upward so as to terminate at an upper end. A cross member is secured at a location on the upper end of elongated support and includes two horizontal extending supports. The two outside supports have a smaller extending square tube inside and has holes drilled every inch on center so pins can be put in to adjust to the width of the elongated article and to secure the back side, another horizontal member that pins to the outside extending supports.

The hitch portion that extends from the motorcycle has a hole in the bottom for a ball hitch. Instead of the ball, a mechanical threaded bolt is secured to the base plate, which is put in the hole and a threaded nut to secure to the trailer hitch. An additional bottom back support that pins on the back underside and goes forward and is placed between the trailer hitch and the securing nut.

The brake light and license plate are going to be covered up any time you hang something on the back of a bike. Because of this, the back upright portion of said carrier has a place for license plate and plate light; also two brake and running lights are put on each side to comply with motor vehicle laws.

It is often a desire of a motorcycle driver to have quick access to the golf bag or, if using the box insert, ball bats, fishing poles or camping equipment. As is often the case, nearly all motorcycles do not have enough, or safe enough, space where an elongated item can be hauled or carried in a safe fashion. Such devices must be easily removed from the motorcycle. Said motorcycle has other uses than carrying golf clubs, fishing poles, etc. The trailer hitch may be needed to perform other duties, such as towing a trailer.

### BRIEF DESCRIPTION OF THE DRAWING

FIG. 1 is the side view of the carrying apparatus for use with a motorcycle according to the present invention shows where the elongated support and hitch receiving portions of the carrying apparatus.

FIG. 2 front view of the carrying apparatus for use with a motorcycle according to the present invention.

FIG. 3 shows the top view of the elongated support. It shows the horizontal topside support arms and the inner extending or retracting arms secured with pins.

FIG. 4 underbase, plate shows the additional support and the round tubes used to run light wires through.

FIG. 5 back view of carrying apparatus. It to shows the elongated support.

FIG. 6 shows the front view of box insert.

FIG. 7 shows top view of box insert.

FIG. 8 side view of box insert.

List of Parts:

1. Lock washer

5. Mechanical bolt

6. Motorcycle hitch

8. Mounting hole for underside support

9. Motorcycle hitch

12. Nut for mechanical bolt

13. Aft mount for underneath base plate

15. Forward upright plate

19. Backside upright license plate, plate light mounting

24. Underbase aft brace

36. License Plate mount

39. Base support to up right

40. Horizontal member

41. License Plate Light mount

44. Mounting holes for brake-running lights

45. Base plate hole for light wire

46. Gussets

50. Vertical members

52. Base plate

61. Upper holes

76. Pins for upper holes

77. Containing means

81. Tube for light wires

99. Box insert

100. Golf bag

101. CARRY-HAUL

### DESCRIPTION OF THE PREFERRED EMBODIMENT

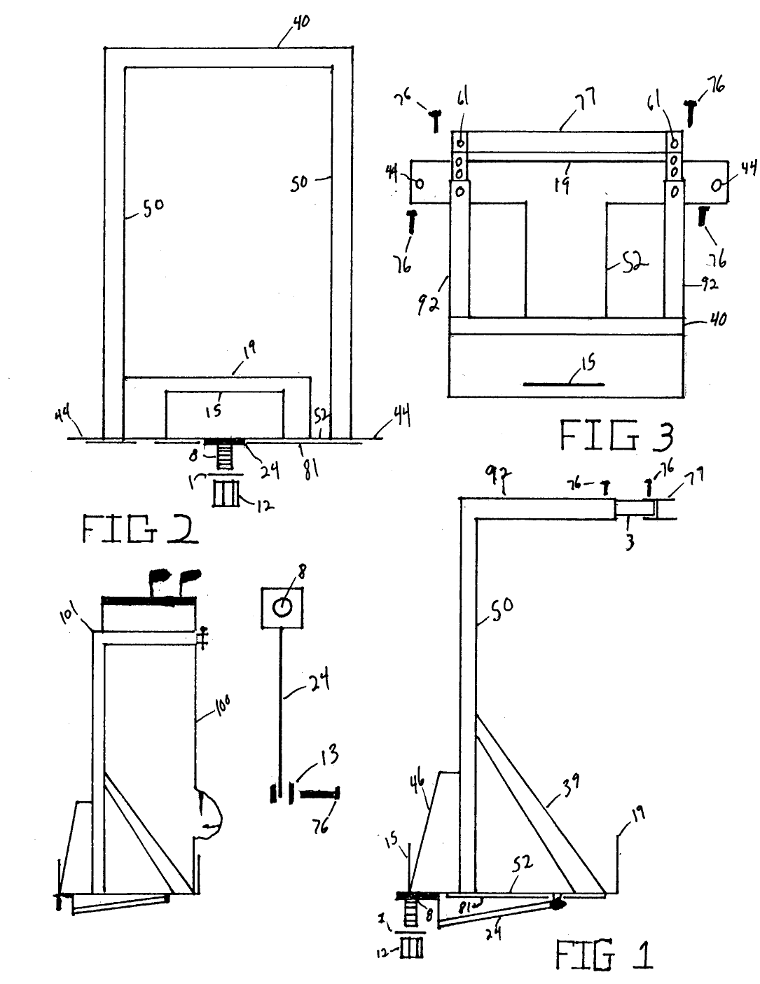

With reference to FIG. 1 a carrying apparatus 101 illustrates according, to a preferred embodiment of the present invention as further best shows FIG. 2-3, the carrying apparatus 101 is very capable of supporting an elongated article like a golf bag in an upright and extending fashion from a rearwardly projecting hitch receiver portion 6 of a motorcycle. The receiver portion 6 may be of a type which is available at most motorcycle sales, and is tubular bar supports with a rearwardly projecting flat end.

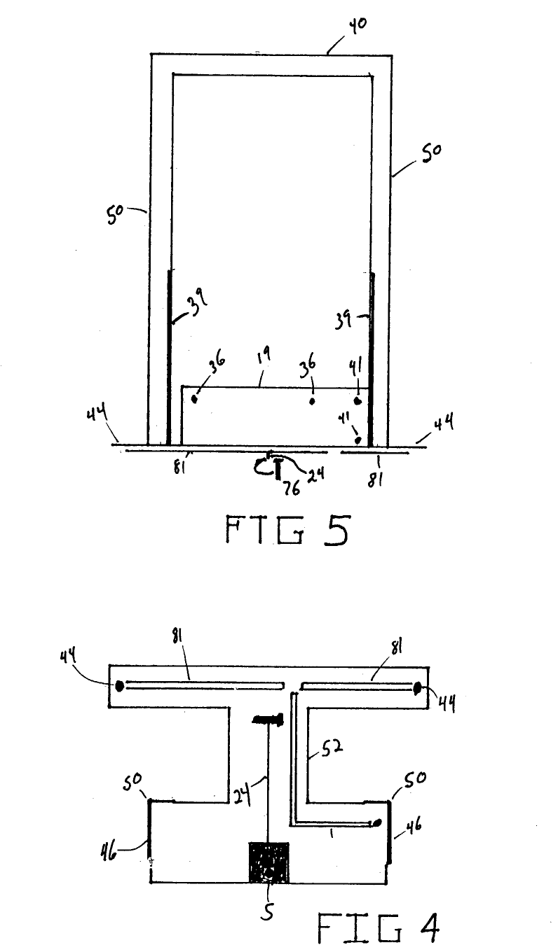

FIG. 1 and also to FIG. 2-3-4 the carrying unit includes a base 52 is best shown in FIG. 3, includes a floor 52 with upright edges front and back 15-19, to keep elongated articles from sliding into the motorcycle or sliding off the back end. The base 52 cam is made of any durable load-carrying material which can be steel or a lightweight alloy, or other durable material. An elongated support 50 is provided and preferably constructed of a member having a shape capable of handling load forces in more than one direction. The elongated support 50 secured to base 52 and sides 39-46 establishes a steady support.

FIG. 1-2 of illustrations, the lower end of the elongated support 50, secured to base 52 such as by welding one to the other to provide a secure connection. The elongated support terminates upwardly at a corresponding end at top 40. FIGS. 2-5, a cross member 40 is secured at a location proximate to the upper end 50 end of the elongated support. As is best shown in FIG. 2-5, the cross member 40 includes a first outwardly extending support portion 92, and a second opposite and outwardly extending support portion 92. The first and second outwardly extending support portions 3. Telescopically engaged with a tubular member 92, of the cross member 40 and a receiving apparatus 50 of the upright support for securing the cross member 40 to the elongated support, again by welding or other means known to secure said material.

The first and second outwardly extending support portions 92, further include inner tubular shaped members 3, which slide and telescope, engage over opposing end of the tubular member 92. The tubular member 92 provides engaging surfaces which permit the inner members 3 a range of telescoping inward and outward repositioning as in FIG. 1-3. The two outside upper outwardly supports include inner members and further includes pairs of spaced apart and aligned apertures 61 formed in upper and lower surfaces of the hollow elongated square tube 92 along axially extending and predetermined ranges associated with the extending sides of the members 92.

Looking at FIG. 3, the first and second out tubular members 3, are provided with first and second pairs of aligning apertures 61 which are formed through opposite faces of the members 3 and are possible through their hollow interiors. Again, FIG. 1-3 pins 76 are inserted through the aligning pairs of apertures. Selected pairs of apertures 61 to allow for repositioning of the inner tubular member 3 at selected axial distance relative to the central member 40. The pins 76 are designed so that they are easily withdrawn or retracted and the tubular members 3, repositioned as desired.

### DESCRIPTION OF THE PREFERRED EMBODIMENT (CONTINUED)

FIGS. 1-3 show a containing means 77, for an elongated article or box insert 99. Said support made up of a tubular member and has apertures 61 on each end held in place by pins 76 on each end of tubular member, so either side or both can be pulled to release said elongated article or box insert 99. According to a preferred embodiment, the outwardly ends of the support portions are constructed so that they may be biasingly engaged by associated upper ends of an elongate article to be supported and are capable of bearing a specified load resistance resulting from carrying of such articles or box insert 99.

In a preferred embodiment, a first elongated tubular member extends from the first outwardly end 3 from the first tubular member 92, and a second elongated 3 extends from the second outwardly tubular end 92. Then, on the backside of the elongated article, golf bag 100 or box insert 99, and with pins in each side, said elongated article is said to be secure.

While a hollow square tubular containing 77 is preferred to secure, it is also understood that other types of securing means may be provided by bungee cords. Rubber tie downs with hooks (not shown) may alternatively be employed to help secure the golf bag 100 or box insert, within scope of the present invention. FIGS. 1-4 show underbase 52 a supporting solid member running from the mechanical bolt to the aft section. This member consists of a plate 24, with a hole in it, big enough to go over the mechanical bolt 8 and then back to underside of base where it is held in place with a retractable pin 13. This helps to stabilize the aft part of base 52, where the elongate article 100 or box insert 99 is placed on the topside. FIG. 1 a hitch-receiving portion 6 is secured to a selected point along the horizontal elongate support 52. The hitch-receiving portion 6 is substantially flat and includes an inserting end.

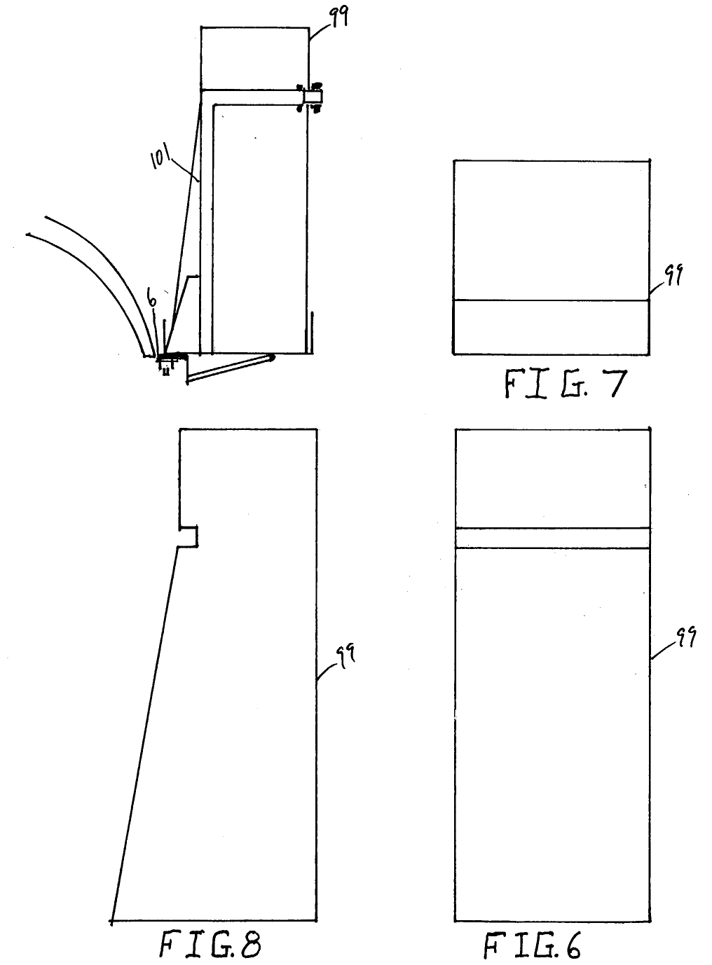

A gusset plate construction 46 provides reinforcing support to the carrying apparatus to the base hitch receiving portion 52. It also envisioned that other types of reinforcing support may be used in place of the gusset plates 46, or that a heavy duty connection between the base 52 receiving portion is done by welding, or the like. Again, FIGS. 1-2 show a mechanical bolt 8 is capable of being inserted through aligning aperture 6 FIG. 1. And includes underside support plate 24 and 8, lock washer and threaded nut 12 to be placed on the mechanical bolt and tighten with a pipe wrench or suitable application. As FIG. 1 the carrying apparatus is illustrated according to an operative view for supporting elongated article such as a golf bag 100 and or box insert as shown in FIGS. 6-7-8 an upper and rearwardly projecting and suspend fashion from the motorcycle 9. It is envisioned, according to the present invention, that at least one golf bag 100, or such enclosed elongated article, be supported. It is also envisioned that other and additional types of elongated articles may be quickly and easily secured and demounted from the carrying apparatus according to the present invention with one such being the box insert 99, to help carry a variety of small items in a safe environment.

FIG. 5 shows where the license plate mounts 19 and the mounting apertures 36. It also shows where the plate light mounts 41. Said rearwardly upright is also used to keep an elongated article in place as shown in FIGS. 2-3.

### DESCRIPTION OF THE PREFERRED EMBODIMENT (CONTINUED)

the resulting structure is extremely rigid and resists loads in all directions. This considerable rigidity has been achieved without the use of massive framing members or the other components to provide a light carrier.

Having thus defined the invention, it should be apparent that numerous structural modifications and applications may be resorted to without departing from the spirit of the invention set forth here in above and defined here in by the claims.

I claim:

1. A motorcycle rearwardly carrier for supporting elongated articles such as a golf bag. Said carrier to be bolted on rear of motorcycle with proper trailer style hitch where a ball hitch can be removed and said carrier put in place and secured with a threaded nut on a mechanical bolt secured to base of carrier.

2. The carrier of claim 1 further characterized in that said bag support is upright and has support on both sides, not only from the base, but also from the upper end support of carrier.

3. The structure of claim 2 further characterized in that said horizontal bag support has an upright on the motorcycle side and an upright on the back end to hold elongated article to shift back and forth while going down the highway.

4. The structure of claim 1 further characterized for added support under the base section that connects to the motorcycle hitch runs back to the aft part of base and is held in place by a pin and a flat member that connects to the base hitch mechanical bolt.

5. The structure of claim 3 further characterized in that said back upright plate on base is also used to hold the license plate and also a light to illuminate a license plate.

6. Another item about claim 5. The upright that holds the license plate and light, on each side of this is also a brake, running light for added safety.

7. A motorcycle carrier that bolts on the rearwardly part of a motorcycle that has a base as said in claim 1, and has upright structures to hold said article with adjusting hollow tubes that connect upright. The hollow tubes weigh less and are used to extend or retract to fit the width of an article and a back containing means to hold back upper end of elongated article.

8. The motorcycle carrier of claim 1 is also used with the box insert to haul loose articles in a safe manner. This is held in place as stated in claims 2-7.

9. The motorcycle carrier of claim 8, when using the box insert and containing means is used properly, said insert can't out or up because the box base is wider than the midsection where contained at.

10. The motorcycle carrier bolts onto the rear and the tail license plate light on the back of said carrier connects to the motorcycle through a quick disconnect thereby permitting a motorcycle rider to haul elongated articles on carrier as an integral part of the motorcycle.
